(19) United States
(12) Patent Application Publication
(10) Pub. No.: US 2009/0179026 A1
(43) Pub. Date: Jul. 16, 2009

(54) APPARATUS FOR DETECTING DETERIORATION OF A HEATER AND APPARATUS FOR CONTROLLING ENERGIZATION OF A GLOW PLUG

(75) Inventors: Hisaharu Morita, Aichi-ken (JP); Hironao Yamaguchi, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/353,362

(22) Filed: Jan. 14, 2009

(30) Foreign Application Priority Data
Jan. 15, 2008 (JP) 2008-006164
Nov. 13, 2008 (JP) 2008-291240

(51) Int. Cl. H05B 1/02

(52) U.S. Cl. 219/497

(57) ABSTRACT

The present invention provides, as one aspect, an apparatus for detecting deterioration of a heater. The apparatus includes a power source, a first voltage outputting unit that converts a current flowing into the heater to a voltage and outputs a first voltage value, a second voltage outputting unit that is connected to the power source and outputs a second voltage value corresponding to a voltage of the power source, and a comparison unit that compares the first voltage value with the second voltage value to determine whether the heater is deteriorated or not.

### CROSS REFERENCE TO RELATED APPLICATION

This application is based on and claims the benefit of priority from earlier Japanese Patent Application No. 2008-6164 filed Jan. 15, 2008 and Japanese Patent Application No. 2008-291240 filed Nov. 13, 2008, the descriptions of which are incorporated herein by reference.

### BACKGROUND OF THE INVENTION

1. Technical Field of the Invention

The present invention relates to an apparatus for detecting deterioration of a heater, more particularly, to an apparatus for controlling energization of a glow plug which is provided in a diesel engine or the like and contains a heater whose deterioration is subject to detection.

2. Related Art

Conventionally, a system is known which detects breaking of a wire of a heater made of metal or ceramic.

For example, Japanese Patent Application Laid-open Publication No. 11-182400 discloses this kind of system, which detects breaking of a wire of a heater contained in a glow plug provided so as to project into the combustion chamber of a diesel engine. When the diesel engine starts in a state where outside temperature is low and temperature in the combustion chamber is low, the temperature in the combustion chamber does not reach the ignition temperature regardless of compressing the air in the combustion chamber. This cannot provide normal combustion. To solve this problem, the glow plug is used to provide normal combustion in the combustion chamber, that is, to raise the temperature so in the combustion chamber to the ignition temperature before the engine starts. The wire of the heater contained in the glow plug often breaks due to deterioration with time or the like. Hence, a system for detecting breaking of the wire of the heater is used to monitor the potential difference across the heater. When the potential difference is equal to or more than a predetermined value, the system determines that the wire of the heater is broken.

Although the conventional system can detect breaking of a wire of a heater, it cannot detect deterioration of the heater. The heater deteriorates due to repeated energization. Thereby, the resistance of the heater increases or decreases. Consequently, the heater comes into the state in which it cannot offer the desired performance. Thereafter, the wire of the heater breaks. Until the heater breaks, the system erroneously recognizes that the heater operates normally. Therefore, the temperature in the combustion chamber is not sufficiently increased by the glow plug contained in the heater during the period between the time when the heater comes into the state in which it cannot offer desired performance and the time when the wire of the heater breaks. Consequently, the engine starts in a state in which the temperature in the combustion chamber is low, and discharges a large amount of hydrocarbons. This can adversely affect the vehicle emissions.

In recent years, glow plugs have been used not only for starting the engine but also for afterglow or post-glow. Therefore, since these glow plugs are used in harsher environments compared with conventional ones used in only for starting the engine, they can deteriorate earlier.

### SUMMARY OF THE INVENTION

The present invention has been invented in view of such problems, and it is therefore an object of the present invention to provide an apparatus for detecting deterioration of a heater and an apparatus for controlling energization to a glow plug.

In order to achieve the object, the present invention provides, as one aspect, an apparatus for detecting deterioration of a heater, comprising: a power source; a first voltage outputting unit that converts a current flowing into the heater to a voltage and outputs a first voltage value; a second voltage outputting unit that is connected to the power source and outputs a second voltage value corresponding to a voltage of the power source; and a comparison unit that compares the first voltage value with the second voltage value to determine whether the heater is deteriorated or not.

### BRIEF DESCRIPTION OF THE DRAWINGS

In the accompanying drawings:

FIG. 1 is a diagram schematically showing a configuration of a glow plug energization control system of an embodiment.

FIG. 2 is a diagram showing an external view of the glow plug energization control system of the embodiment.

FIG. 3 is a diagram showing a connection state of the glow plug energization control system and the periphery thereof.

FIG. 4 is a diagram showing an electric circuit A1 of the glow plug energization control system of a first embodiment.

FIG. 5 is a graph showing deterioration with time (migration phenomenon) of a ceramic heater of the embodiment.

FIG. 6 is a graph showing variation of VB, Vi and Vref with respect to time.

FIG. 7 is a graph showing deterioration with time (migration phenomenon) of the ceramic heater of the embodiment.

FIG. 8 is a graph showing variation of VB, Vi and Vref with respect to time.

FIG. 9 is a graph showing a relationship between Vref and VB.

FIG. 10 is a graph showing a deterioration mode of a glow plug.

FIG. 11 is a diagram showing an electric circuit A2 of the glow plug energization control system of a second embodiment.

FIG. 12 is a graph showing variation of VB, Vi, Vref1 and Vref2 with respect to time.

FIG. 13 is a diagram showing an electric circuit A3 of the glow plug energization control system of a third embodiment.

FIG. 14 is a diagram showing an electric circuit A4 of the glow plug energization control system of a fourth embodiment.

FIG. 15 is a diagram showing an electric circuit A5 of the glow plug energization control system of a fifth embodiment.

FIG. 16 is a diagram showing an electric circuit E1 of the glow plug energization control system of a modification example.

FIG. 17 is a diagram showing an electric circuit E2 of the glow plug energization control system of a modification example.

FIG. 18A is a graph showing the time constant of Vi with respect to time.

FIG. 18B is a graph showing the time constant of Vref with respect to time.

FIG. 19 is a diagram showing an electric circuit A6 of the glow plug energization control system of a modification example.

FIGS. 20A to 20D are graphs showing relationships between VB and Vref.

### DETAILED DESCRIPTION OF THE PREFERRED EMBODIMENTS

### First Embodiment

An apparatus for detecting deterioration of a heater according to the embodiment is suited to be used to detect deterioration of the heater incorporated in a glow plug provided in a diesel engine or the like. Hereinafter, a glow plug energization control unit 6 (hereinafter, referred to as “GCU 6”), which detects deterioration of the heater contained in the glow plug and controls energization of the glow plug, will be described with reference to the accompanying drawings.

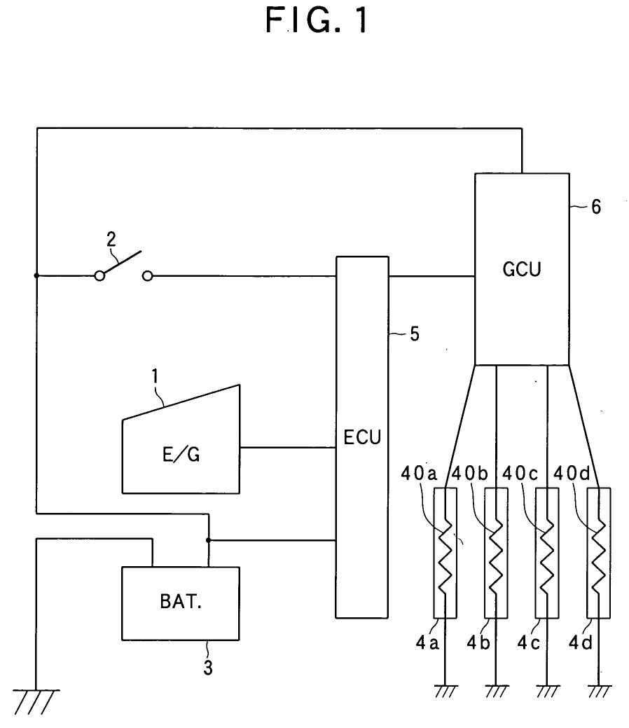

FIG. 1 is a diagram schematically showing a configuration of a glow plug energization control system including the GCU 6. As shown in FIG. 1, the system is mainly configured with a key switch 2, a battery 3, glow plugs 4a, 4b, 4c and 4d, an electronic control unit 5 (hereinafter, referred to as “ECU 5”), and the GCU 6. The battery 3 corresponds to a power source, and the GCU 6 corresponds to the apparatus for detecting deterioration of a heater.

An engine 1 is provided with four cylinders. The glow plugs 4a to 4d are mounted on the four cylinders so as to project into combustion chambers, respectively. When the key switch 2 is turned to the ON position, the GCU 6 controls energization and de-energization of the glow plugs 4a to 4d based on a control signal sent from the ECU 5.

Ceramic heaters 40a to 40d are built in the glow plugs 4a to 4d, respectively. The ceramic heaters 40a to 40d are heated due to the energization, thereby raising the temperature in the combustion chambers. The ceramic heaters 40a to 40d correspond to heaters.

Vehicle information such as voltage of the battery 3, temperatures in the combustion chambers, ON/OFF signals of the key switch 2 and the like are transmitted to the ECU 5. The ECU 5 controls energization of the glow plugs 4a to 4d based on the vehicle information. This control is preferably performed by pulse width modulation control.

When the key switch 2 is turned to the ON position, the GCU 6 energizes the glow plugs 4a to 4d based on a pulse width modulation signal (hereinafter, referred to as “PWM signal”) sent from the ECU 5. Specifically, before the engine 1 starts, when the temperature in the combustion chambers is low and required to be raised, an effective voltage of 11 V, for example, is applied from the battery 3 to the glow plugs 4a to 4d.

After the engine 1 starts, it is preferable to perform afterglow for equal to or more than 10 minutes to maintain the temperature in the combustion chambers at, for example, 900° C. Thereby, the stability of the combustion characteristic is improved. Specifically, when the glow plugs 4a to 4d are energized by afterglow control, an effective voltage of 7 V, for example, is applied for 20 to 30 minutes to maintain the temperature in the combustion chambers at 900° C.

Alternatively, after the engine 1 starts, post-glow control may be performed based on a PWM signal sent from the ECU 5 as is the case with the afterglow control. Due to the post-glow control, PM (Particulate Matter) clogging a DPF (Diesel Particulate Filter) (not shown) is burned to restore the DPF. The post-glow control temporarily raises the temperature in the combustion chambers to 900° C. to generate high-temperature exhaust gas. In consequence, the high-temperature exhaust gas passes through the DPF to burn the PM, thereby restoring and cleaning the DPF. The post-glow control also applies an effective voltage of 7 V from the battery 3 to the glow plugs 4a to 4d.

When the key switch 2 is turned to the OFF position, the GCU 6 stops the energization of the glow plugs 4a to 4d.

Hereinafter, a structure and electric circuits of the GCU 6 will be described.

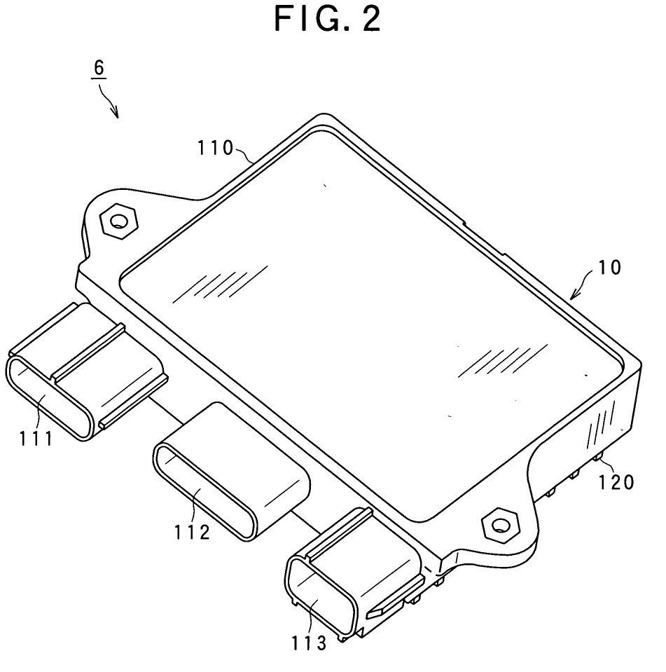

FIG. 2 is a perspective view showing an external view of the GCU 6. A housing 10 of the GCU 6 comprises a resin portion 110 made of hard resin such as PPS and PBT and a heat radiation portion 120 including a plurality of fins made of metal such as aluminum.

As shown in FIG. 2, a first connector 111, a second connector 112, and a third connector 113 project from an outer surface of the housing 10. The first connector 111 connects the GCU 6 to the battery 3. The second connector 112 connects the GCU 6 to the four glow plugs 4a to 4d. The third connector 113 connects the GCU 6 to the ECU 5. The connectors 111 to 113 are formed integrally with the resin portion 110 by the hard resin.

The housing 10 has a space inside of it. The housing 10 contains electric circuits A1, B1, C1 and D1 which implement characteristic operations of the present embodiment, which are described later, in the space. Heat generated by the electric circuits A1, B1, C1 and D1 is radiated to the outside of the housing 10 through the heat radiation portion 120 shown in FIG. 2. In the housing 10, gelatinous silicon resin or the like is enclosed to protect the electric circuits A1 to D1 from water and moisture.

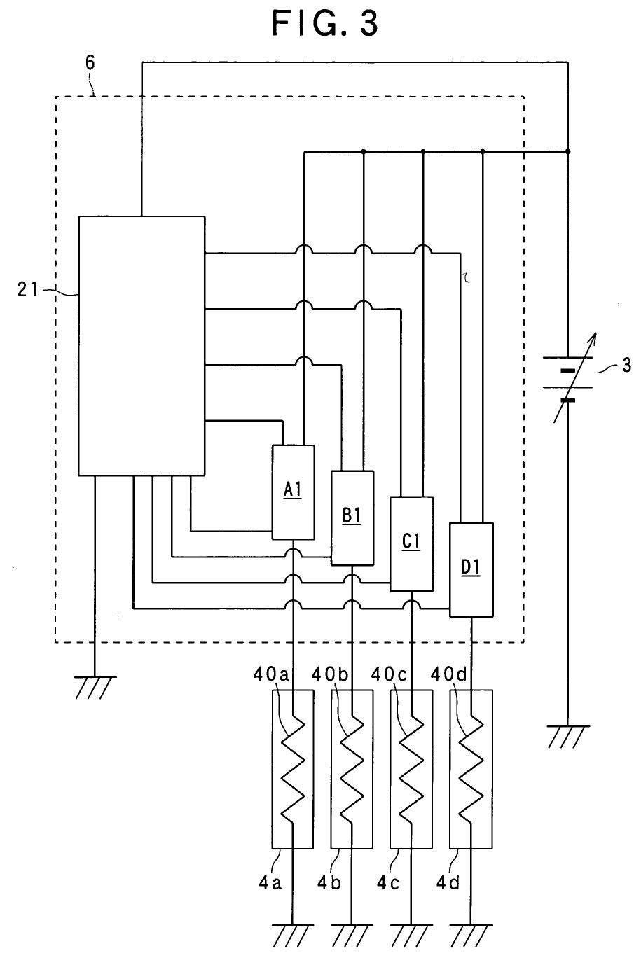

FIG. 3 is a diagram showing an electrical connection state of the battery 3, the four glow plugs 4a to 4d, and the electric circuits A1 to D1 contained in the space inside the housing 10 shown in FIG. 2. The electric circuits A1 to D1 are energized by the battery 3 and receive PWM signals from a control chip 21. Then, the glow plugs 4a to 4d are appropriately energized, while the electric circuits A1 to D1 perform operations described later.

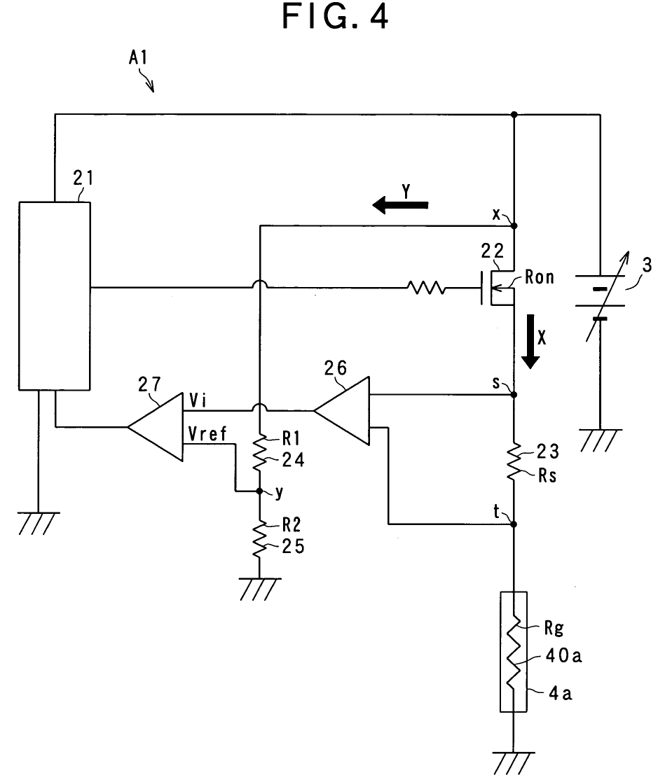

The electric circuits A1 to D1 relate to the glow plugs 4a to 4d, respectively. Each of the electric circuits A1 to D1 comprises a power chip 22, a shunt resistor 23, a resistor 24, a resistor 25, a differential is amplifier 26, and a comparator 27, which are shown in FIG. 4. The whole GCU 6 comprises the single control chip 21. In the present embodiment, each of the electric circuits A1 to D1 has a similar configuration and implements similar control. Therefore, for the sake of simplicity, the electric circuit A1 of the GCU 6, which energizes the glow plug 4a, will be taken as an example to describe, hereinafter, characteristic configurations and operations of the present embodiment.

FIG. 4 is a diagram schematically showing the electric circuit A1 of the GCU 6. The battery 3 energizes the glow plug 4a via the power chip 22 and the shunt resistor 23 which are arranged on a path X. At the same time, voltage obtained by clamping across the shunt resistor 23 is applied to the differential amplifier 26. The differential amplifier 26 outputs a first voltage value to the comparator 27. The shunt resistor 23 and the differential amplifier 26 correspond to a means for outputting a first voltage value (first voltage outputting unit). The comparator 27 corresponds to a means for comparison and discrimination (comparison unit).

The electric circuit A1 is grounded via the resistors 24 and 25 arranged on a path Y. A second voltage value, which is a voltage divided by the resistors 24 and 25, is outputted to the comparator 27. The resistors 24 and 25 correspond to a means for outputting a second voltage value (second voltage outputting unit).

Hereinafter, elements and operations of the electric circuit A1 shown in FIG. 4 will be described in detail.

The control chip 21 contained in the GCU6 shown in FIG. 4 is electrically connected to the electric circuits A1 to D1 shown in FIG. 3 and the ECU 5. The control chip 21 transmits signals to the power chip 22 based on PWM signals outputted from the ECU 5. The control chip 21 is an integrated circuit which controls switching timing of the power chip 22.

The power chip 22 is a switching element configured with, for example, a vertical MOSFET (Metal-Oxide Semiconductor Field-Effect Transistor) having three terminals and is electrically connected to the control chip 21 via bonding wires. The power chip 22 switches between energization of the glow plug 4a by the battery 3 and de-energization. The power chip 22 has an ON resistor Ron.

The shunt resistor 23 is arranged on the electric path X on which the battery 3 is connected to the glow plug 4a via the power chip 22. On starting energization, a high current of tens of amperes, for example, 50 A flows on the path X. Therefore, it is preferable to set the resistance value Rs of the shunt resistor 23 to 5 mΩ or less to prevent energy loss due to heat generation in the shunt resistor 23. Note that since the shunt resistor 23 has low temperature dependence, the resistance value of the shunt resistor 23 hardly varies even when the temperature of the shunt resistor 23 rises due to the heat generation.

The path Y is provided from a point x positioned upstream of the power chip 22 so as to be parallel with the path X. The path Y is grounded via the resistors 24 and 25. The resistors 24 and 25 have resistance values R1 and R2, respectively. The resistor 24 is arranged upstream of the resistor 25 on the path Y.

On the path X, both ends s and t of the shunt resistor 23 are clamped and electrically connected to the differential amplifier 26, such as an operational amplifier, or a differential amplifier circuit. The differential amplifier 26 outputs voltage Vi, which is a voltage drop due to the current flowing through the shunt resistor 23, to the comparator 27. The voltage Vi corresponds to the first voltage value. In the present embodiment, gain G of the differential amplifier 26 is set to 10. A point y positioned upstream of the resistor 25 and downstream of the resistor 24 is connected to the comparator 27. Battery voltage VB is divided between the resistors 24 and 25. Reference voltage Vref corresponds to a potential at the point y. The point y outputs the reference voltage Vref associated with the battery voltage VB to the comparator 27 positioned downstream of the point y. The reference voltage Vref corresponds to the second voltage value.

The comparator 27, into which Vi and Vref are inputted, compares Vi with Vref. For example, when Vi>Vref, the comparator 27 outputs a “High” signal. When Vi≦Vref, the comparator 27 outputs a “Low” signal.

The electric circuits A1 described above detects deterioration of the glow plug 4a as described below.

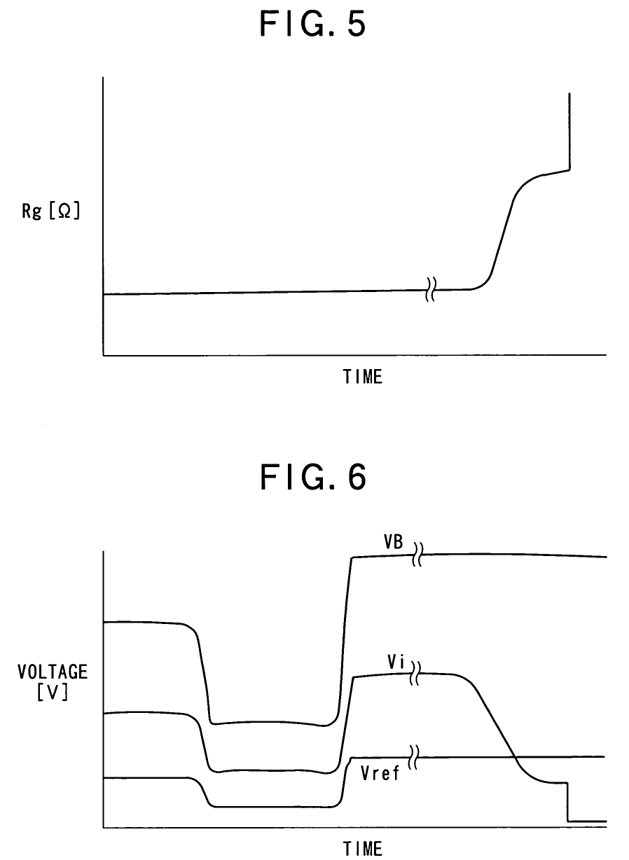

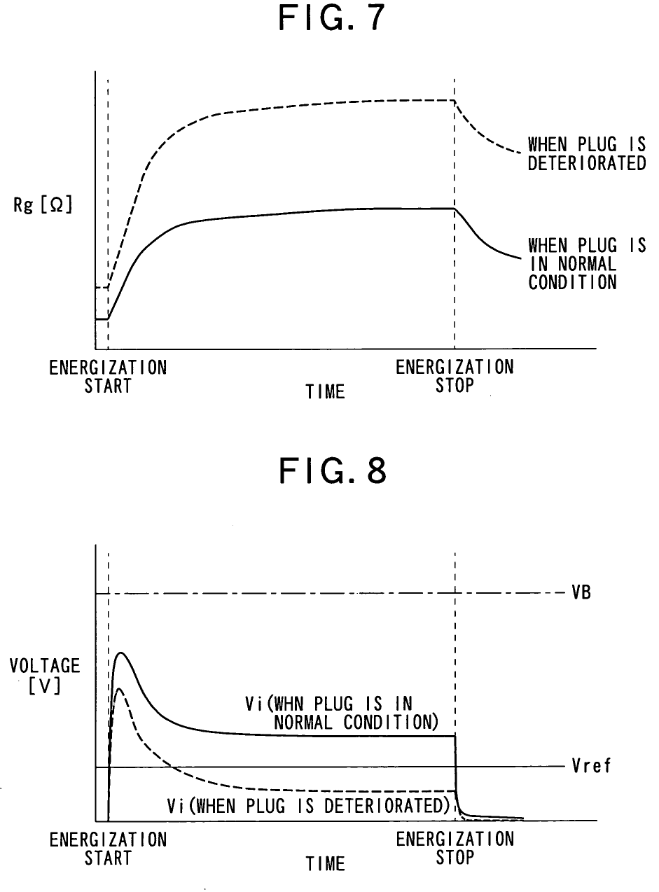

FIGS. 5 and 7 are diagrams showing deterioration with time of the ceramic heater 40a of the present embodiment. In FIGS. 5 and 7, the vertical axis shows resistance value Rg of the ceramic heater 40a and the horizontal axis shows time. FIGS. 5 and 7 demonstrate that the ceramic heater 40a deteriorates due to repeated energization, and the resistance value Rg when the heater is deteriorated increases compared with that when the heater is in normal condition. The deterioration of the ceramic heater 40a increases the resistance value Rg due to the migration phenomenon which decreases the amount of electrically conductive ceramics in the ceramic heater.

As described above, the migration phenomenon increases the resistance value Rg of the ceramic heater 40a. When the comparator 27 outputs a “Low” signal to the control chip 21, that is, when Vi≦Vref, the control chip 21 determines that the ceramic heater 40a is deteriorated and informs the driver of the problem with the vehicle. Even when the glow plug 4a is suddenly broken without deterioration due to external factors, the control chip 21 informs the driver of the problem with the vehicle in the same manner as in the case where the deterioration is detected.

FIGS. 6 and 8 are diagrams showing variation of VB, Vi and Vref with respect to time. In FIGS. 6 and 8, the vertical axis shows voltage [v] and the horizontal axis shows time. As the resistance value Rg increases due to the deterioration with time of the ceramic heater 40a as described above, the current flowing thorough the path X decreases, and the voltage Vi, which is a voltage drop caused by the shunt resistor 23, also decreases. Considering the voltage drop caused by the shunt resistor 23 provided on the path X, voltage Vi outputted from the differential amplifier 26 is expressed as follows:

Vi=G×VB×Rs/(Ron+Rs+Rg) [expression 1]

As described above, the ceramic heater 40a deteriorates with time, and the resistance value Rg thereof increases. When the resistance value Rg exceeds a predetermined threshold value K, it is assumed that heat is insufficiently generated in the ceramic heater. Thereby, the glow plug 4a cannot offer desired performance. That is, when Rg≧K, the glow plug 4a is assumed to be deteriorated and the expression 1 is modified as follows:

Vi≦G×VB×Rs/(Ron+Rs+K) [expression 2]

In addition, since the reference voltage Vref is obtained by dividing voltage VB between the resistors 24 and 25 on the path Y, the following expression is obtained.

Vref=VB×R2/(R1+R2) [expression 3]

The comparator 27 compares Vi with Vref. When Vi≦Vref, the comparator 27 determines that the ceramic heater 40a is deteriorated and outputs a “Low” signal to the control chip 21. Furthermore, when Vi=Vref, the threshold value K of the resistance value of the ceramic heater 40a is derived from, based on the expressions 1 to 3, the following expression 4:

R2/(R1+R2)=G×Rs/(Ron+Rs+K) [expression 4]

In the expression 4, the threshold value K of the resistance value Rg of the ceramic heater 40a may be set according to a performance evaluation test, and thereafter, the resistors 24 and 25 may be selected which have resistance values R1 and R2 satisfying the expression 4. For example, K, R1 and Rs are set to 1Ω, 19 kΩ and 1 kΩ, respectively. In consequence, when the glow plug 4a is deteriorated or broken, which is an abnormal state, that is, when the resistance value Rg of the ceramic heater 40a exceeds the threshold value K, the relation between Vi and Vref, which are inputted into the comparator 27, becomes Vi≦Vref. Thereby, the comparator 27 outputs a “Low” signal to the control chip 21. The control chip 21 outputs a signal indicating the abnormal state including the deterioration to the ECU 5. The ECU 5 turns on, for example, a warning lamp on the instrumental panel (not shown) of the vehicle to inform the driver of the problem with the vehicle.

Respective resistance values Ron, Rs, R1 and R2 of the power chip 22, shunt resistor 23, resistors 24 and 25 vary as in the case of the resistance value Rg of the ceramic heater 40a. However, the extents of the increases of Ron, Rs, R1 and R2 are negligibly small compared with that of Rg. Therefore, in the present embodiment, it is presumed that Ron, Rs, R1 and R2 are not increased, that is, are not increased with time and are substantially constant. However, it is preferable that the threshold value K is set in consideration of the increases with time of the resistance values Ron, Rs, R1 and R2 to detect deterioration of the glow plug 4a more accurately.

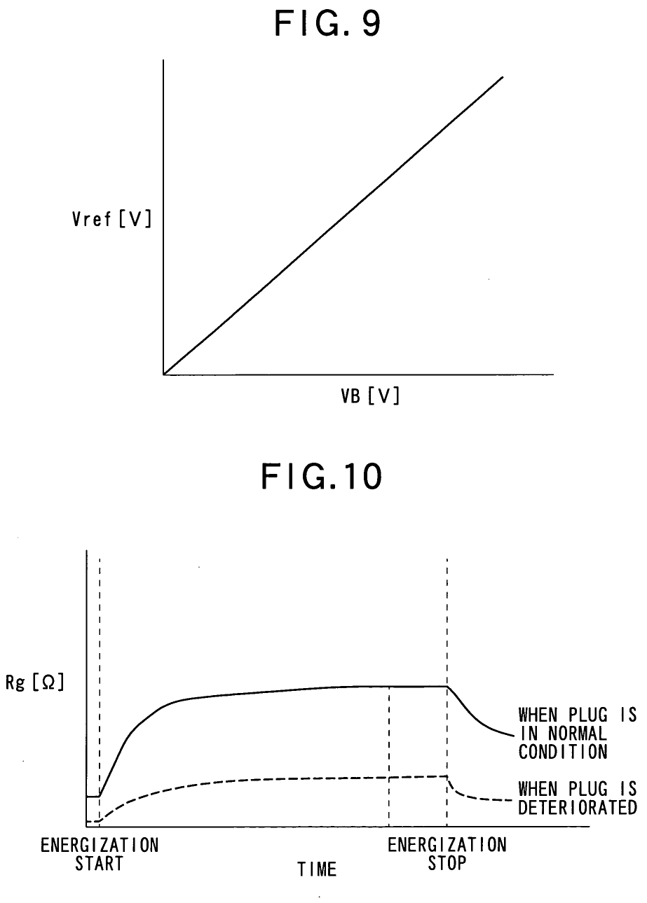

In the above description, as shown in FIG. 8, it is presumed that the battery 3 does not deteriorate with time. However, in practice, voltage VB of the battery 3 gradually drops as the battery 3 is used for a long period. Accordingly, Vi and Vref also drop. However, as demonstrated in FIG. 9 which shows a relation between Vref and VB and as shown by the expression 4, even when VB drops, since the ON resistor Ron of the power chip 22 and the resistance Value Rs of the shunt resistor 23 are substantially constant and the threshold value K does not depend on VB, Vi and Vref, the deterioration of the glow plug 4a can be detected accurately.

When the energization of the glow plug 4a starts and when the energization stops, the relation between Vi and Vref is Vi≦Vref regardless of the presence or absence of the deterioration of the glow plug 4a. In consequence, when the energization starts and when the energization stops, the comparator 27 outputs a “Low” signal to the control chip 21. Therefore, even when the glow plug 4a operates normally, the glow plug 4a is erroneously determined to be deteriorated. To prevent such a situation, the ECU 5 performs control as described below. Under the control, when the energization starts, the comparator 27 does not perform comparison between Vi and Vref for a predetermined period of time, for example, about 5 seconds. When the energization stops, the comparator 27 does not perform the comparison at all.

In the above embodiment, the electric circuit A1 detecting the deterioration of the glow plug 4a is described. Since the other glow plugs 4b to 4d are connected with the electric circuits B1 to D1 which have similar configurations as that of the electric circuit A1, it is possible to detect the deterioration of the glow plugs 4b to 4d in the same manner as in the case of the electric circuit A1 described above. In addition, the PWM signal transmitted from the ECU 5 to the control chip 21 is referred to as an instruction duty signal, which is processed in the control chip 21. Thereafter, the control chip 21 transmits channel duty signals to the power chips 22 provided in the electric circuits A1 to D1 to control the energization of the glow plugs 4a to 4d in different phases.

### Second Embodiment

Hereinafter, the second embodiment will be described. Since the basic configuration of the second embodiment is the same as that of the above first embodiment, only characteristic portions will be described. The same reference numerals as in the first embodiment denote the same parts in the second embodiment.

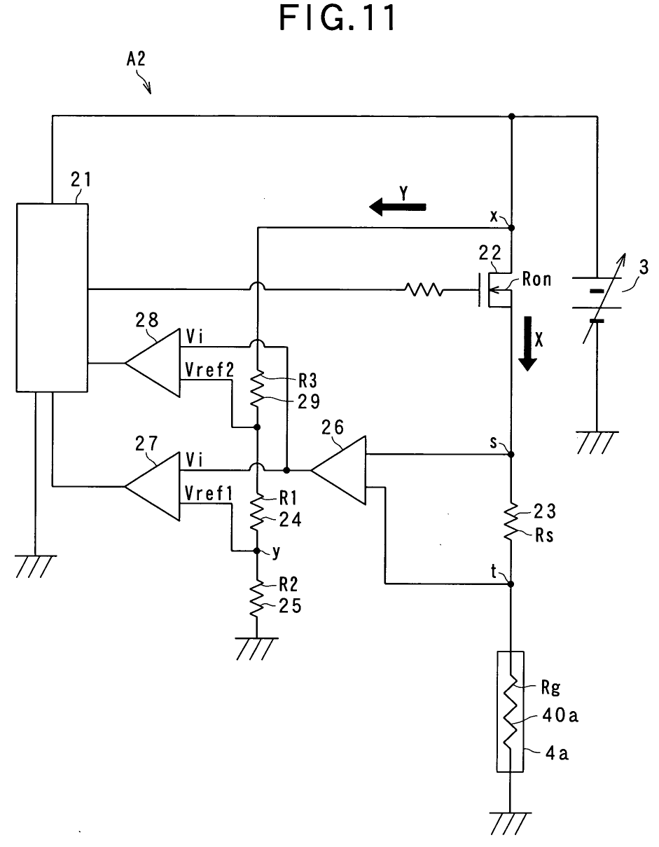

In the above first embodiment, glow plugs 4a to 4d are configured with ceramic glow plugs containing ceramic heaters 40a to 40d. The deterioration of the glow plugs 4a to 4d are detected based on the characteristic in which the resistance values of the ceramic heaters 40a to 40d increase as they deteriorate due to the migration phenomenon. In practice, as shown in FIG. 10, the resistance value of the ceramic glow plug may be decreased due to its deterioration. In that case, for example, a partial short circuit called a layer short is caused by the contact between a ceramic conductive part or wiring part and a case. In addition, even when a metal glow plug made of nichrome wire or the like is used instead of the ceramic glow plug, its resistance value can increase or decrease due to its deterioration. Specifically, two situations can be anticipated when the metal glow plug is used. In one situation, the resistance value of the metal glow plug increases because the radius of a metal heater wiring therein decreases. In the other situation, the resistance value of the metal glow plug decreases because the layer short is caused by the contact between the metal heater wiring and the case.

As described above, since the resistance value of the glow plug 4a increases or decreases depending on the type of the glow plug 4a or a plurality of deterioration modes of the glow plug 4a, the GCU 6 of the embodiment employs an electric circuit A2 which can detect deterioration in response to the above various deterioration modes of the glow plug 4a. That is, the deterioration of the glow plug 4a whose resistance value varies due to the deterioration thereof can be reliably detected by the GCU 6. The glow plug 4a may be a metal glow plug or a ceramic glow plug.

Specifically, the electric circuit A2 shown in FIG. 11 is applied to the GCU 6. The electric circuit A2 is configured by adding a comparator 28 to the electric circuit A1 show in FIG. 4 of the first embodiment. Vi is inputted into the comparator 28 from the node between the output side of the amplifier 26 and the input side of the comparator 27.

Next, different two reference voltages Vref1 and Vref2 associated with the voltage Vref are inputted into the comparators 27 and 28, respectively. The comparators 27 and 28 correspond to means for comparison and discrimination (comparison unit).

On the path Y, three resistors 25, 24 and 29, which have mutually different resistance, are serially-connected in this order from the ground side to the upper stream side. The resistors 25, 24 and 29 correspond to the means for outputting a second voltage value (second voltage outputting unit).

The reference voltage Vref1, which is obtained by dividing the battery voltage by the resistances of resistors 25, 24 and 29, is obtained as follows:

Vref1=VB×R2/(R1+R2+R3) [expression 5]

Similarly, the reference voltage Vref2 is obtained as follows:

Vref2=VB×(R1+R2)/(R1+R2+R3) [expression 6]

Vref1 and Vref2 are inputted into the comparators 27 and 28, respectively. Here, resistance values of the resistors 25, 24 and 29 are set to 1 kΩ, 2 kΩ and 17 kΩ, respectively, and Vref1 is set to less than Vref2. In the following description, it is assumed that following expression is satisfied.

Vref1<Vi<Vref2 [expression 7]

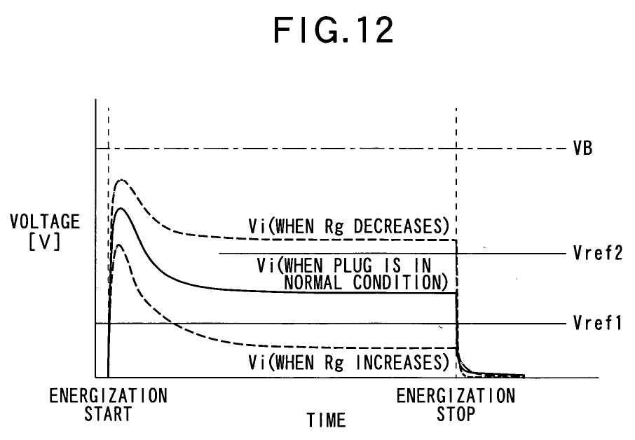

FIG. 12 is a diagram showing a mechanism of detecting deterioration of the glow plug of the present embodiment. FIG. 12 is associated with FIG. 8 of the first embodiment. As shown in FIG. 12, when Vref1<V1, due to the condition of the glow plug 4a, the comparator 27 outputs a “High (no deterioration)” signal to the control chip 21. When Vi<Vref2, due to the condition of the glow plug 4a, the comparator 28 outputs a “High (no deterioration)” signal to the control chip 21. That is, when Vi satisfies the expression 7, the glow plug 4a is determined as not being deteriorated. When Vi does not satisfy the expression 7, the glow plug 4a is determined as being deteriorated. In this manner, the upper limit and the lower limit of Vi are defined by the resistors 24, 25 and 29 and the comparators 27 and 28 to allow the deterioration of the glow plug 4a to be detected depending on the type of the glow plug 4a or the plurality of deterioration modes of the glow plug 4a.

Note that it is preferable to properly change resistance values of the resistors 25, 24 and 29 depending on the type and characteristic of the glow plug 4a.

### Third Embodiment

Hereinafter, the third embodiment will be described. Since the basic configuration of the third embodiment is the same as those of the above first and second embodiments, only characteristic portions will be described. The same reference numerals as in the first and second embodiments denote the same parts in the third embodiment.

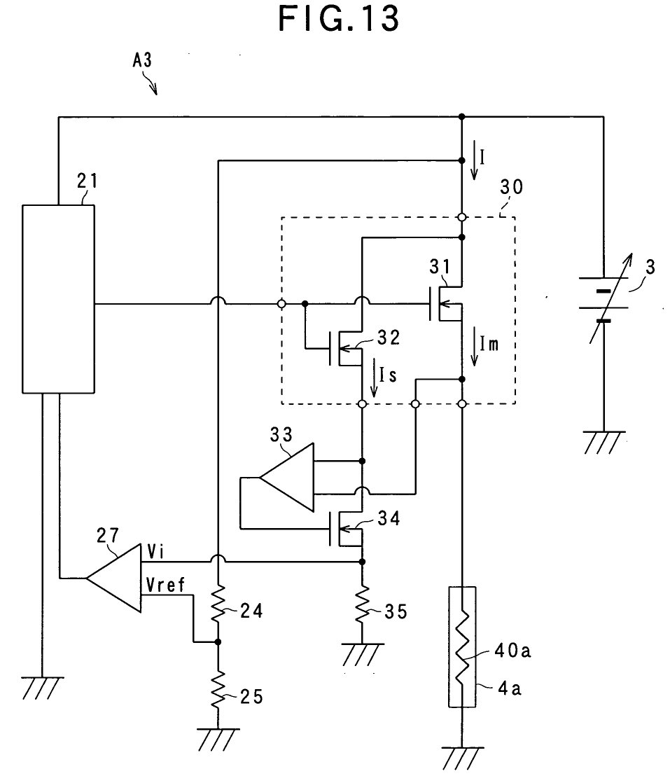

FIG. 13 is a diagram showing an electric circuit A3 of the present embodiment. As shown in FIG. 13, a sense MOS (sense MOSFET) 30 is provided on the battery 3 side of the glow plug 4a. The sense MOS 30 controls energization of the glow plug 4a. The sense MOS 30 comprises a main element 31 and a sense element 32 and divides load current I flowing from the battery 3 into main current Im flowing through the main element 31 and sense current Is flowing through the sense element 32. The main element 31 controls energization of the glow plug 4a. Since a so part of the load current I flowing into the sense MOS 30 flows through the sense element 32, the sense element 32 serves to monitor the main current Im flowing through the main element 31. That is, the sense MOS 30 is a current mirror circuit in which the ratio between the main current Im flowing through the main element 31 and the sense current Is flowing through the sense element 32 is constant.

A gate of the main element 31 and a gate of the sense element 32 are mutually connected to each other. The ratio of the size of the main element 31 to the size of the sense element 32 is n to 1. In the present embodiment, the ratio is 1500 to 1.

A feedback circuit is configured with an operational amplifier 33 and a transistor 34 arranged downstream of the sense element 32. The amplifier 33 corresponds to an amplification means. The feedback circuit keeps the respective terminal voltages of the main element 31 and the sense element 32 (i.e. drain-to-source voltage, hereinafter, referred to as “Vds”) constant. That is, an inverting input terminal (−) of the operational amplifier 33 is connected to a source of the main element 31. A non-inverting input terminal (+) of the operational amplifier 33 is connected to a source of the sense element 32. An output terminal of the operational amplifier 33 positioned at the downstream side thereof is connected to a gate of the transistor 34. A drain of the transistor 34 is connected to the source of the sense element 32. A shunt resistor 35 is arranged at the ground side of the transistor 34. The shunt resistor 35 corresponds to the means for outputting a first voltage value (first voltage outputting unit).

As described above, the feedback circuit is configured with an operational amplifier 33 and a transistor 34 and controls Vds of the main element 31 and Vds of the sense element 32 to be equal to each other. In consequence, in the current mirror circuit, the ratio between the current flowing through the main element 31 and the current flowing through the sense element 32 can be set to correspond to the ratio of the size of the main element 31 to the size of the sense element 32. That is, when the ratio of the size of the main element 31 to the size of the sense element 32 is n to 1, the sense current Is, which is 1/n of the main current Im of the main element 31, can stably flow into the sense element 32 side.

Owing to the shunt resistor 35 connected to the source side of the transistor 34, Vi is detected based on the sense current Is. Vi is inputted into the comparator 27. Thereafter, the comparator 27 compares Vi with Vref associated with VB to determine whether the glow plug 4a is deteriorated or not. As described above, the load current I is divided into Im flowing through the main element 31 and the sense current Is. The sense current Is, which is relatively small, is used to detect the deterioration of the glow plug 4a. Thereby, heat generation of the shunt resistor 35 can be suppressed. Note that the main element 31 and the sense element 32 are configured with field-effect transistors.

### Fourth Embodiment

Hereinafter, the fourth embodiment will be described. Since the basic configuration of the fourth embodiment is the same as those of the above first to third embodiments, only characteristic portions will be described. The same reference numerals as in the first to third embodiments denote the same parts In the fourth embodiment.

The present embodiment is a combination of the first and third embodiments and has an electric circuit A4.

FIG. 14 is a diagram showing an electric circuit A4 of the present embodiment. As shown in FIG. 14, a sense MOS (sense MOSFET) 36 is used as a switching element which controls energization of the glow plug 4a. The sense MOS 36 divides current into sense current Is flowing through the shunt resistor 23, which is connected to the source side of the sense MOS 30 in parallel, and main current Im flowing through the glow plug 4a in the sense ratio of 1 to 1000. According to the configuration, the deterioration of the glow plug 4a can be detected accurately. Furthermore, the current flowing through the shunt resistor 23 is sufficiently small compared with that of the first embodiment, thereby allowing energy loss due to heat generation of the shunt resistor 23 to be suppressed.

### Fifth Embodiment

Hereinafter, the fifth embodiment will be described. Since the basic configuration of the fifth embodiment is the same as those of the above first to fourth embodiments, only characteristic portions will be described. The same reference numerals as in the first to fourth embodiments denote the same parts in the fifth embodiment.

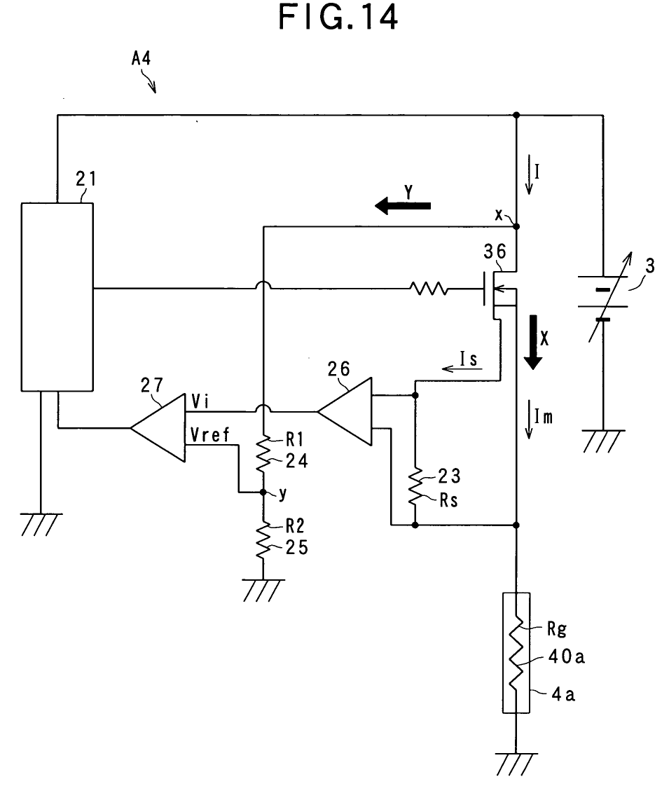

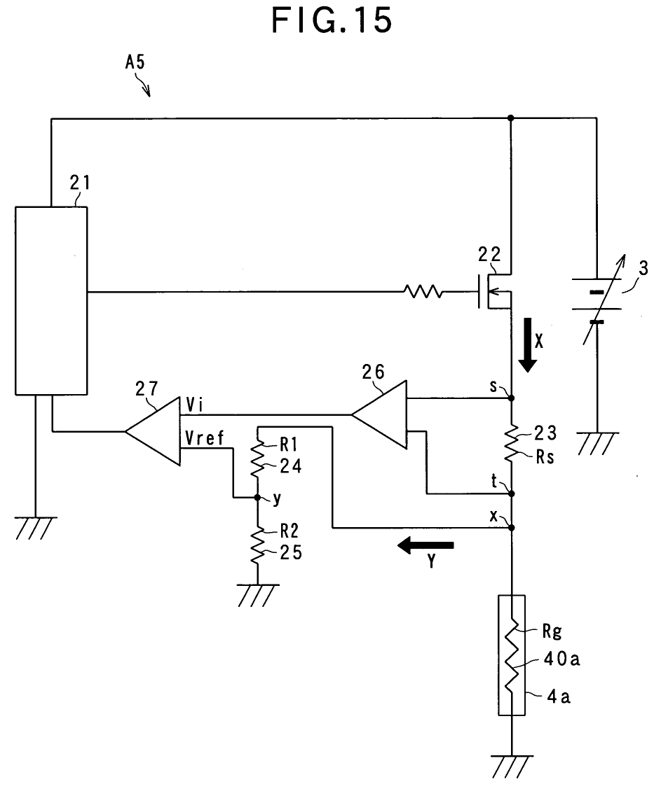

FIG. 15 is a diagram showing an electric circuit A5 of the present embodiment. As shown in FIG. 15, the point x described in the first embodiment is positioned downstream of the point t and upstream of the glow plug 4a. Therefore, since the point x and the point t are substantially at the same potential, the effect on the reference voltage Vref on the path Y can be eliminated which is caused by the variation of resistance values of the power chip 22 and the shunt resistor 23 due to the voltage drop of the elements 22 and 23 or the like. Thereby, the comparator 27 can detect the deterioration of the glow plug 4a accurately while the power chip 22 is turned on under the PWM control of the control chip 21.

### Other Embodiments

In the above first to fifth embodiments, Vi is a voltage value obtained by converting the load current I flowing from the battery 3 to voltage using the shunt resistor 23 or 35, and Vref is a voltage value obtained by converting the load current I to voltage using the resistors 24, 25 and 29. Vi and Vref are inputted into the comparator 27 to detect the deterioration of the glow plug 4a. However, signals inputted into the comparator 27 are not limited to the voltage values Vi and Vref. Current values Ii and Iref inputted into a current comparison circuit described later may be used as the signals.

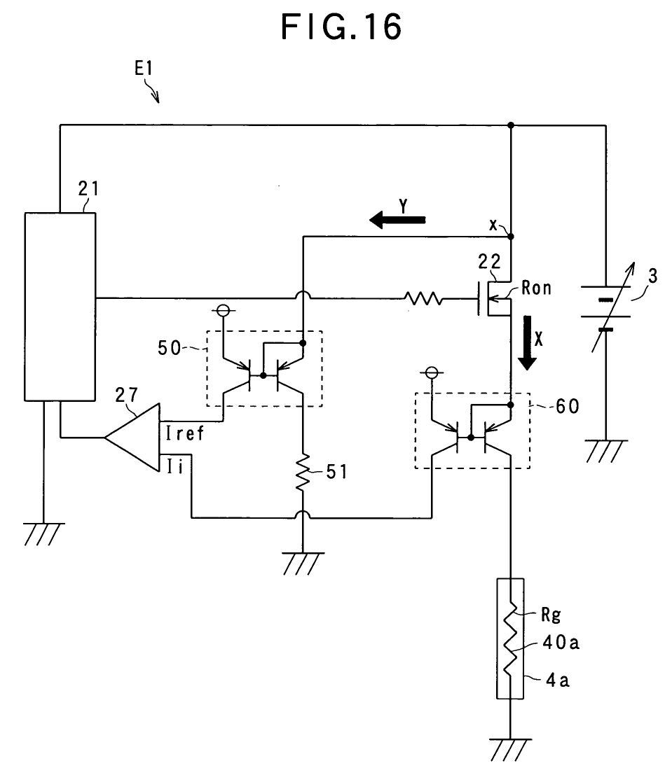

FIG. 16 is a diagram showing an electric circuit E1. As shown in FIG. 16, a current mirror circuit 50 and a resistor 51 are arranged on the path Y in series instead of the resistors 24 and 25 shown in FIG. 4. The current mirror circuit 50 outputs Iref. A current mirror circuit 60 is arranged instead of the shunt resistor 23 shown in FIG. 4. The current mirror circuit 60 outputs Ii. This electric circuit E1 can also detect the deterioration of the glow plug 4a as is the case with the above embodiments.

In the present embodiment, Ii corresponds to a first current value and Iref corresponds to a second current value. The current mirror circuit 60 corresponds to a current regulation means. The current mirror circuit 50 and the resistor 51 correspond to a means for outputting a second current value. It is preferable to configure the current mirror circuits 50 and 60 with semiconductor chips for miniaturizing the electric circuit E1. In FIG. 16, the current mirror circuit 60 divides current flowing into the glow plug 4a in the ratio of 1 to 1. The current may be is divided in the ratio of 1 to 3 to decrease the value Ii. Thereby, heat generation of the wire, which outputs Ii, and the comparator 27 can be suppressed.

FIG. 17 is a diagram showing an electric circuit E2. Advantages similar to those of the above embodiment can be provided by using the electric circuit E2. As shown in FIG. 17, a current mirror circuit 70 and a current regulator 52 are arranged instead of the resistor 35 and the operational amplifier 33 shown in FIG. 13, respectively. The current regulator 52 does not perform differential amplification and has a function for keeping the sense current Is constant. The comparator 27 performs comparison and discrimination between Ii and Ired to detect the deterioration of the glow plug 4a. The current regulator 52 corresponds to the current regulation means.

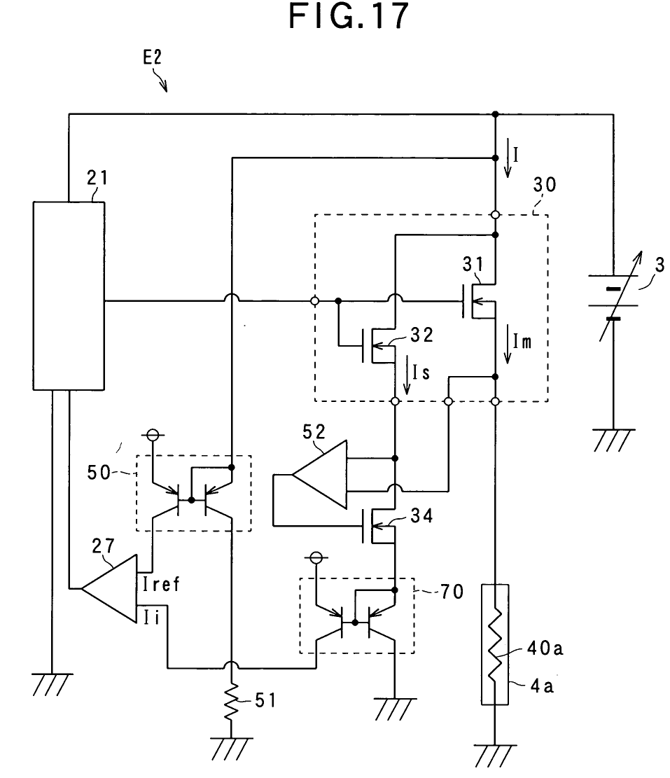

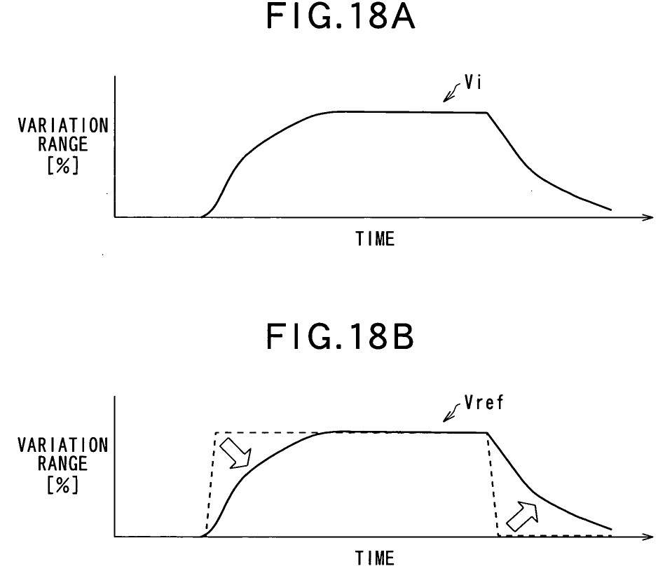

In the above first to fifth embodiments, Vi and Vref, which are inputted into the comparator 27, differ in time constants, because the Vi side is provided with an operation means such as a differential amplifier and an operational amplifier. As shown in FIG. 18A, the time constant of Vi gradually varies compared with that of Vref. Therefore, when Vi and Vref are compared with each other by the comparator 27 in the steady state, deterioration of the glow plug 4a can be correctly determined. However, when Vi and vref are compared with each other by the comparator 27 in the transient state (which can be shown in a gradual curve of Vref), deterioration of the glow plug 4a can be incorrectly determined. To solve this problem, a configuration such as an electric circuit A6 shown in FIG. 19 may be provided. In the electric circuit A6, an RC circuit configured with a resistor 41 and a capacitor 42 is provided on the output path of Vref to the comparator 27. Owing to this configuration, the time constants of Vi and Vref match with each other. Thereby, the comparator 27 can correctly determine the deterioration of the glow plug 4a in the transient state of Vi and Vref as well as the steady state. Instead of using the so-called low-pass filter such as an RC circuit to cancel a first-order tag and to match the responses with each other, a digital filter may be used to cut dead time and match the responses with each other The resistor 41 and the capacitor 42 correspond to a response adjustment means (response adjustment unit). Note that it is preferable to arrange the response adjustment means in the electric circuits E1 and E2, which detect deterioration by using Ii and Iref, to match the responses of Ii and Iref with each other (not shown).

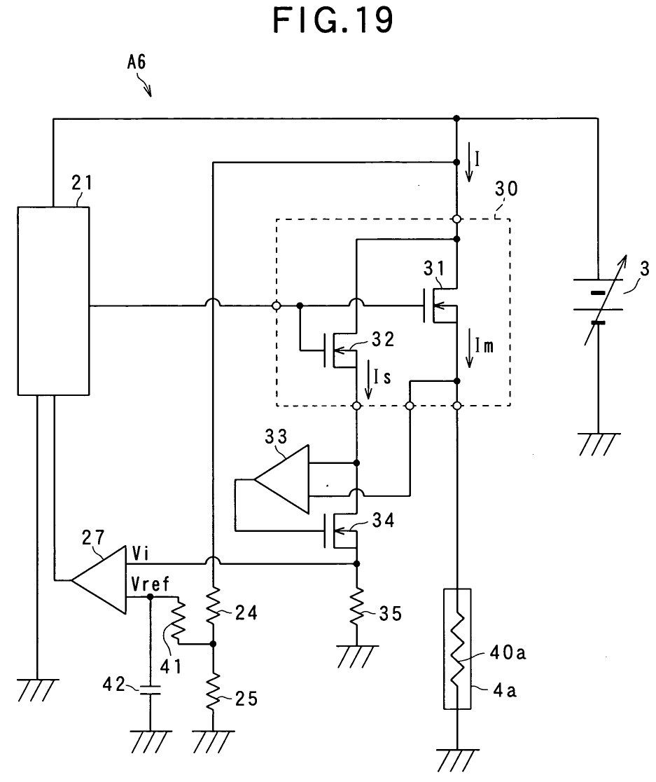

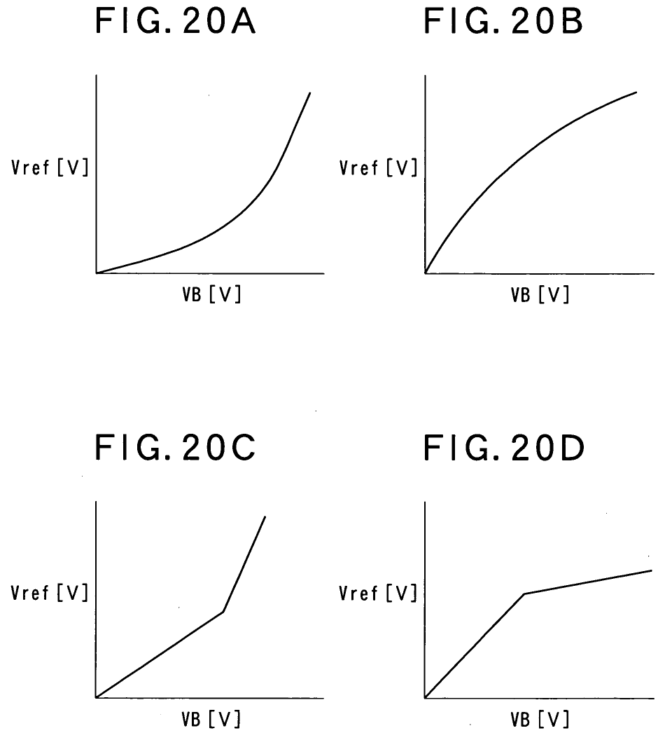

Furthermore, although VB and Vref have the proportionality between them in the above first to fifth embodiments, the relationship between VB and Vref is not limited, on condition that VB and Vref have a correlation between them. The relationships between VB and Vref may be shown in FIGS. 20A to 20D which are curve graphs and line graphs.

In addition, although an electric circuit is used to implement the desired control, the above-described control for detecting deterioration may be implemented by using an inexpensive electronic circuit or software. Thereby, the GCU 6 can be miniaturized and reduced in weight.

Furthermore, the number of electric circuits in the GCU 6 is the same as that of glow plugs and is not limited by the number of cylinders of the engine 3.

Note that although the apparatus for detecting deterioration of a heater is applied to the GCU 6 in the above embodiments, the apparatus may be applied to units containing a heater such as a ceramic fan heater.

In the above first to fifth embodiments, the electric circuits A1 to A6 are described. For example, when a four-cylinder engine is used, the electric circuits A1 to A6, E1, or E2 may be selectively applied to the electric circuits B to D.

### SUMMARY

An apparatus for detecting deterioration of a heater comprises a power source, a first voltage outputting unit that converts a current flowing into the heater to a voltage and outputs a first voltage value, a second voltage outputting unit that is connected to the power source and outputs a second voltage value corresponding to a voltage of the power source, and a comparison unit that compares the first voltage value with the second voltage value to determine whether the heater is deteriorated or not.

That is, in the apparatus, the first voltage value outputted from the first voltage outputting unit and the second voltage value outputted from the second voltage outputting unit are subject to operation in the comparison unit. When the comparison unit determines that the heater is deteriorated, the comparison unit outputs a signal indicating the deterioration. Thereby, the deterioration of the heater can be detected.

In addition, both the first voltage outputting unit and the second voltage outputting unit output signals associated with the voltage of the power source. Even when a large current flows, for example, when the temperature is low or when cranking, or even when the voltage of the power source varies due to deterioration with time of the power source, both the first voltage value and the second voltage value inputted into the comparison unit correlate with the voltage of the power source. Thereby, the comparison unit can detect the deterioration of the heater regardless of the variation of the voltage of the power source.

Another apparatus for detecting deterioration of a heater comprises a first voltage outputting unit that converts a current flowing into the heater to a voltage and outputs a first voltage value, a second voltage outputting unit that is connected to the heater and outputs a second voltage value corresponding to a voltage applied to the heater, and a comparison unit that compares the first voltage value with the second voltage value to determine whether the heater is deteriorated or not.

That is, in the apparatus, the first voltage value outputted from the first voltage outputting unit and the second voltage value outputted from the second voltage outputting unit are subject to operation in the comparison unit. When the comparison unit determines that the heater is deteriorated, the comparison unit outputs a signal indicating the deterioration. Thereby, the deterioration of the heater can be detected.

In addition, both the first voltage outputting unit and the second voltage outputting unit output signals associated with the voltage applied to the heater. Even when a large current flows, for example, when the temperature is low or when cranking, or even when the voltage applied to the heater varies due to deterioration with time of the power source or electric elements, both the first voltage value and the second voltage value inputted into the comparison unit are proportionate to the voltage applied to the heater. Thereby, the comparison unit can detect the deterioration of the heater regardless of the variation of the voltage applied to the heater.

In the apparatus, the first voltage outputting unit has a sense MOS (Metal-Oxide Semiconductor) and converts a part of the current flowing into the heater to a voltage and outputs the first voltage value. The current flowing into the heater is divided by the sense MOS, which allows the first voltage value to be adjusted. Thereby, heat generation of the first voltage outputting unit can be reduced.

In the apparatus, the first voltage outputting unit has a shunt resistor and outputs the first voltage value as a voltage drop caused by the shunt resistor. Since the shunt resistor has low temperature dependence, first voltage value can be outputted accurately even when the temperature of the first voltage outputting unit becomes high.

In the apparatus, the second voltage outputting unit has a plurality of resistors connected in series and outputs the second voltage value as a voltage divided by the plurality of resistors. Thereby, the second voltage value can be a desired value depending on resistance values of the plurality of resistors. In addition, the second voltage value inputted into the comparison unit can be associated with the voltage of the power source.

In the apparatus, energization of the heater is controlled with pulse width modulation by using a switching element. The first voltage outputting unit has an amplification means for amplifying the first voltage value, and the second voltage outputting unit has a response adjustment means such as a low-pass filter If the second voltage outputting unit does not have the response adjustment means, the response of the first voltage outputting unit having the amplification means is slow compared with that of the second voltage outputting unit. Therefore, in the transient state in which the first voltage value and the second voltage value are inputted into the comparison unit, the comparison unit can not accurately detect the deterioration of the heater because of the difference between the response of the first voltage outputting unit and the response of the second voltage outputting unit. To solve the problem, the second voltage outputting unit is provided with the response adjustment means to match the response of the first voltage outputting unit with the response of the second voltage outputting unit. Thereby, the comparison unit can accurately determine the deterioration of the heater in the transient state.

Another apparatus for detecting deterioration of a heater comprises a power source, a first current outputting unit that outputs a first current value corresponding to a current flowing through the heater, a second current outputting unit that converts a voltage of the power source to a current and outputs a second current value, and a comparison unit that compares the first current value with the second current value to determine whether the heater is deteriorated or not.

That is, in the apparatus, the first current value outputted from the first current outputting unit and the second current value outputted from the second current outputting unit are inputted into the comparison unit. When the comparison unit determines that the heater is deteriorated, the comparison unit outputs a signal indicating the deterioration. Thereby, the deterioration of the heater can be detected.

In addition, both the first current outputting unit and the second current outputting unit output signals associated with the voltage of the power source. Even when a large current flows, for example, when the temperature is low or when cranking, or even when the voltage of the power source varies due to deterioration with time of the power source, both the first current value and the second current value inputted into the comparison unit correlate with the voltage of the power source. Thereby, the comparison unit can detect the deterioration of the heater regardless of the variation of the voltage of the power source.

Another apparatus for detecting deterioration of a heater comprises a first current outputting unit that outputs a first current value corresponding to a current flowing into the heater, a second current outputting unit that is connected to the heater and converts a voltage applied to the heater to a current and outputs a second current value, and a comparison unit that compares the first current value with the second so current value to determine whether the heater is deteriorated or not.

That is, in the apparatus, the first current value outputted from the first current outputting unit and the second current value outputted from the second current outputting unit are inputted into the comparison unit. When the comparison unit determines that the heater is deteriorated, the comparison unit outputs a signal indicating the deterioration. Thereby, the deterioration of the heater can be detected.

In addition, both the first current outputting unit and the second current outputting unit output signals associated with the voltage applied to the heater. Even when a large current flows, for example, when the temperature is low or when cranking, or even when the voltage applied to the heater varies due to deterioration with time of the power source, both the first current value and the second current value inputted into the comparison unit correspond to the voltage applied to the heater. Thereby, the comparison unit can detect the deterioration of the heater regardless of the variation of the voltage applied to the heater.

In the apparatus, the first current outputting unit has a sense MOS. Thereby, the current flowing into the heater is divided to output the first current value. The current flowing into the heater is divided by the sense MOS, which allows the first current value to be adjusted. Thereby, heat generation of the first current outputting unit can be reduced.

In the apparatus, the first current outputting unit has a current sensor. That is, the first current value is detected by the current sensor in the first current outputting unit.

In the apparatus, the second current outputting unit has a resistor and outputs the second current value as a current value flowing through the resistor.

In the apparatus, energization of the heater is controlled with pulse width modulation by using a switching element. The first current outputting unit has a current regulation means for regulating the first current value, and the second current outputting unit has a response adjustment means for adjusting response of the second current value. If the second current outputting unit does not have the response adjustment means, the response of the second current outputting unit having the current regulation means is slow compared with that of the first current outputting unit. Therefore, in the transient state in which the first current value and the second current value are inputted into the comparison unit, the comparison unit can not accurately detect the deterioration of the heater because of the difference between the response of the first current outputting unit and the response of the second current outputting unit. To solve the problem, the second current outputting unit is provided with the response adjustment means to match the response of the first current outputting unit with the response of the second current outputting unit. Thereby, the comparison unit can accurately determine the deterioration of the heater in the transient state.

A glow plug containing a heater is installed in a diesel car. According to the recent legislation of mandatory installation of an in-car diagnostic system around the world, deterioration of the glow plug is required to be indicated to a driver by a warning lamp provided on an instrumental panel or the like. Therefore, the apparatus for detecting deterioration of a heater included in a glow plug is applied to an apparatus for controlling energization of the glow plug. Thereby, the deterioration of the heater included in the glow plug can be detected by the apparatus for controlling energization of the glow plug to successfully follow the regulation.

It will be appreciated that the present invention is not limited to the configurations described above, but any and all modifications, variations or equivalents, which may occur to those who are skilled in the art, should be considered to fall within the scope of the present invention.

What is claimed is:

1. An apparatus for detecting deterioration of a heater, comprising.
a power source;
a first voltage outputting unit that converts a current flowing into the heater to a voltage and outputs a first voltage value;
a second voltage outputting unit that is connected to the power source and outputs a second voltage value corresponding to a voltage of the power source; and
a comparison unit that compares the first voltage value with the second voltage value to determine whether the heater is deteriorated or not.

2. The apparatus according to claim 1, wherein the heater is incorporated in a glow plug.

3. The apparatus according to claim 1, wherein the first voltage outputting unit has a sense MOS (Metal-Oxide Semiconductor) and converts a part of the current flowing into the heater to a voltage and outputs the first voltage value.

4. The apparatus according to claim 1, wherein the first voltage outputting unit has a shunt resistor and outputs the first voltage value as a voltage drop caused by the shunt resistor.

5. The apparatus according to claim 1, wherein the second voltage outputting unit has a plurality of resistors connected in series and outputs the second voltage value as a voltage divided by the plurality of resistors.

6. The apparatus according to claim 1, further comprising a control unit that controls energization of the heater with pulse width modulation, wherein the first voltage outputting unit amplifies the first voltage value and the second voltage outputting unit adjusts response.

7. An apparatus for detecting deterioration of a heater, comprising:
a first voltage outputting unit that converts a current flowing into the heater to a voltage and outputs a first voltage value;
a second voltage outputting unit that is connected to the heater and outputs a second voltage value corresponding to a voltage applied to the heater; and
a comparison unit that compares the first voltage value with the second voltage value to determine whether the heater is deteriorated or not.

8. The apparatus according to claim 7, wherein the first voltage outputting unit has a sense MOS (Metal-Oxide Semiconductor) and converts a part of the current flowing into the heater to a voltage and outputs the first voltage value.

9. The apparatus according to claim 7, wherein the first voltage outputting unit has a shunt resistor and outputs the first voltage value as a voltage drop caused by the shunt resistor.

10. The apparatus according to claim 7, wherein the second voltage outputting unit has a plurality of resistors connected in series and outputs the second voltage value as a voltage divided by the plurality of resistors.

11. The apparatus according to claim 7, further comprising a control unit that controls energization of the heater with pulse width modulation, wherein the first voltage outputting unit amplifies the first voltage value and the second voltage outputting unit adjusts response.

12. An apparatus for detecting deterioration of a heater, comprising:
a power source;
a first current outputting unit that outputs a first current value corresponding to a current flowing into the heater;
a second current outputting unit that converts a voltage of the power source to a current and outputs a second current value; and
a comparison unit that compares the first current value with the second current value to determine whether the heater is deteriorated or not.

13. The apparatus according to claim 12, wherein the first current outputting unit has a sense MOS (Metal-Oxide Semiconductor).

14. The apparatus according to claim 12, wherein the second current outputting unit has a resistor and outputs the second current value as a current value flowing through the resistor.

15. The apparatus according to claim 12, further comprising a control unit that controls energization of the heater with pulse width modulation, wherein the first current outputting unit adjusts the first current value and the second current outputting unit adjusts response.

16. An apparatus for detecting deterioration of a heater, comprising:
a first current outputting unit that outputs a first current value corresponding to a current flowing into the heater;
a second current outputting unit that is connected to the heater and converts a voltage applied to the heater to a current and outputs a second current value; and
a comparison unit that compares the first current value with the second current value to determine whether the heater is deteriorated or not.

17. The apparatus according to claim 16, wherein the first current outputting unit has a sense MOS (Metal-Oxide Semiconductor).

18. The apparatus according to claim 16, wherein the second current outputting unit has a resistor and outputs the second current value as a current value flowing through the resistor.

19. The apparatus according to claim 16, further comprising a control unit that controls energization of the heater with pulse width modulation, wherein the first current outputting unit adjusts the first current value and the second current outputting unit adjusts response.

20. An apparatus for controlling energization of a glow plug, the glow plug including a heater, the apparatus using a heater deterioration detection apparatus, and the heater deterioration detection apparatus comprising:
a power source;
a first voltage outputting unit that converts a current flowing into the heater to a voltage and outputs a first voltage value;
a second voltage outputting unit that is connected to the power source and outputs a second voltage value corresponding to a voltage of the power source; and
a comparison unit that compares the first voltage value with the second voltage value to determine whether the heater is deteriorated or not.
